(19) United States
(12) Patent Application Publication
(10) Pub. No.: US 2010/0145955 A1
(43) Pub. Date: Jun. 10, 2010

(54) METHOD AND SYSTEM FOR VIRTUALLY PRINTING DIGITAL CONTENT TO A SEARCHABLE ELECTRONIC DATABASE FORMAT

(75) Inventors: Jeffrey D. McDonald, Foxborough, MA (US); Lonne R. Lyon, Rochester, NY (US)

Correspondence Address: FOLEY HOAG, LLP;PATENT GROUP, WORLD TRADE CENTER WEST, 155 SEAPORT BLVD, BOSTON, MA, 02110, US

(73) Assignee: SolidFX LLC, Foxborough, MA (US)

(21) Appl. No.: 12/634,931

(22) Filed: Dec. 10, 2009

Related U.S. Application Data
(60) Provisional application No. 61/121,388, filed on Dec. 10, 2008.

(51) Int. Cl. G06F 17/30

(52) U.S. Cl. 707/754; 707/E17.022

(57) ABSTRACT

A computer implemented method and system and computer program product are provided for virtually printing digital content to a searchable electronic database format to facilitate locating or analyzing desired content. The method includes the steps of: (a) providing digital content at a computer system; (b) dividing the digital content into one or more virtual pages; (c) extracting content data from the one or more virtual pages, and storing the content data in a database; and (d) generating associations between the content data and respective virtual pages from which the content data was extracted, and storing the associations in a database.

### CROSS REFERENCE TO RELATED APPLICATION

This application claims priority from U.S. Provisional Patent Application Ser. No. 61/121,388, filed on Dec. 10, 2008, entitled “Method and System for Virtual Printing of Documents to a Searchable Electronic Database Format,” which is hereby incorporated by reference.

### BACKGROUND

The present application generally relates to a computer implemented method and system for virtually printing digital content to a searchable electronic database format to facilitate locating or analyzing desired content.

Committing computer based content to paper through a printing process is a pervasive concept in data processing. The capability to redirect output destined for a printer to instead be stored in an electronic file is less commonly used but still widely available on general purpose computing operating systems. The information produced by the computer's printing subsystem that is streamed to a printer device or captured in a file can take on a variety of formats, limited only by development of appropriate software drivers that support specific printer or file format requirements. For example, such a stream may contain raw textual content, a visual representation through image or bitmap formats, or a complete page layout description through some printer hardware language (e.g., PCL) or a higher level language (e.g., PDF). This process of storing this stream in a computer file rather than sending it to a printer connected to the computer is often termed virtual printing or printing to file.

### BRIEF SUMMARY OF EMBODIMENTS OF THE INVENTION

In accordance with one or more embodiments of the invention, a computer implemented method is provided for virtually printing digital content to a searchable electronic database format to facilitate locating or analyzing desired content. The method includes the steps of: (a) providing digital content at a computer system; (b) dividing the digital content into one or more virtual pages; (c) extracting content data from the one or more virtual pages, and storing the content data in a database; and (d) generating associations between the content data and respective virtual pages from which the content data was extracted, and storing the associations in a database.

In accordance with one or more further embodiments of the invention, a computer system is provided for virtually printing digital content to a searchable electronic database format to facilitate locating or analyzing desired content. The computer system includes at least one processor, memory associated with the at least one processor, and a program supported in the memory. The program includes a plurality of instructions which, when executed by the at least one processor, cause that processor to: (a) divide the digital content into one or more virtual pages; (b) extract content data from the one or more virtual pages, and store the content data in a database; and (c) generate associations between the content data and respective virtual pages from which the content data was extracted, and store the associations in a database.

In accordance with one or more further embodiments of the invention, a computer program product is provided for virtually printing digital content to a searchable electronic database format to facilitate locating or analyzing desired content. The computer program product resides on a computer readable medium having a plurality of instructions stored thereon which, when executed by the processor, cause that processor to: (a) divide the digital content into one or more virtual pages; (b) extract content data from the one or more virtual pages, and store the content data in a database; and (c) generate associations between the content data and respective virtual pages from which the content data was extracted, and store the associations in a database.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a simplified block diagram illustrating an exemplary computer system for virtually printing digital content to a searchable electronic database format in accordance with one or more embodiments of the invention.

FIG. 2 is a flowchart illustrating a method for virtually printing digital content to a searchable electronic database format in accordance with one or more embodiments of the invention.

FIG. 3 is an illustration of exemplary digital content, in this case a Federal Aviation Administration (FAA) approach chart, analyzed in accordance with one or more embodiments of the invention.

### DETAILED DESCRIPTION

Various embodiments of the present application are directed to facilitating the virtual printing of digital content to a searchable electronic database format to facilitate locating or analyzing desired content. In accordance with one or more embodiments of the invention, the digital content is divided into virtual pages. Content data from the virtual pages is extracted and stored in a database. Associations are generated between the content data and the respective virtual pages from which the content data was extracted, and stored in the database.

The term “digital content” refers to any information that can be published or distributed in a digital form including, but not limited to, text, data, and images. The digital content can be in a variety of forms including, but not limited to, digital documents, web pages, digital files, electronically displayed content, or printable content.

In one or more embodiments, the database stores each virtual page as a combination of a visual representation of the virtual page along with associated extracted content data and metadata.

In some embodiments, the system is implemented using generally the same framework, mechanisms, and workflow typically provided by a general purpose computer operating system (e.g., Windows, UNIX, MacOS) to facilitate computer application programs with print functionality to output information to traditional hardcopy printers and print to file functionality. In accordance with one or more embodiments of the invention, this functionality can be implemented separately from a printing subsystem with the following additional considerations:

1. Since source digital content is often stored in a proprietary format, a software interface with the digital content can be used by the described system to facilitate rendering the visual representation of content in a form that would provide other content data and/or metadata. The printer subsystem is well suited to this task as it widely available and is capable of providing a wealth of content data and metadata extraction opportunities, but it should be recognized that it is not uniquely suited.

2. If rendering methods are limited to the production of a visual representation such as an image file having limited or no embedded document data or metadata, Optical Character Recognition (OCR) and image analysis techniques could be used to extract content data and metadata.

As used herein, the term “Virtual Printer Driver” is used to describe any technology used to capture the visual representation of digital content along with associated content data and/or metadata whether or not a general purpose printer subsystem is the implementation framework.

The visual representation may take the form of a digital image or using any page description language—enough information to replicate or replace the visual information presented by the original document or application presentation that was printed. This electronic representation may or may not utilize compression methods to reduce data storage requirements. Non-limiting examples of Visual Representations include Bitmap, JPEG, PDF, PostScript, and PCL (Printer Command Language) files.

Content data may include, but is not limited to character strings, numbers, images or anything else that is displayed or otherwise present in the digital content itself. Non-limiting examples of content data include full text contents, specific strings/text having special significant for use in an application, sub-image component of full visual representation, and metadata.

Metadata includes any other information that can be harvested during the printing process, which does not explicitly appear in the digital content itself. Non-limiting examples of metadata include information on the position and orientation of the content data elements in the virtual pages, font information, content creation date information, author information, content print date information and identification of user who initiated the printing, number of words on the page, and the source of print.

The visual representation of a virtual page can subsequently be viewed electronically on any appropriate display device or be output to any appropriate device including a traditional hardcopy printer. There are a number of methods that can be utilized in isolation or in combination that determine the extent and quality of the digital content data and metadata captured during the electronic printing process. Some methods are generally available to digital content of any type while others require varying degrees of a priori knowledge of the source digital content format and layout. The resulting digital content data and metadata extracted from and associated with the visual representation may be stored and/or made available to search engines to facilitate queries and searches for locating desired pages from the database for subsequent display, analysis, or other utilization (e.g., printing, communicating, storing outside the database). Examples of various digital content data and metadata extraction methods are provided below. The examples demonstrate that a variety of methods can be derived to satisfy given requirements for particular digital content and applications wishing to access or utilize such digital content in electronic database form.

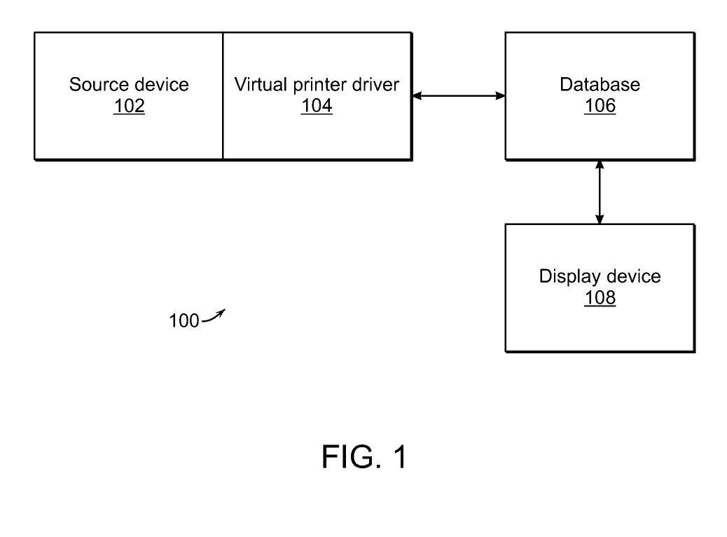

FIG. 1 is a simplified block diagram illustrating an exemplary system 100 that can print digital content from a computer application to a database format in accordance with one or more embodiments. The computer system includes a source device 102, which in some embodiments is a general purpose computer. The source device 102 can run a commercially available operating system that supports one or more applications. The operating system and/or system/software has the ability to support printing operations on one or more types of printing devices. Applications running on the computer can output information to the printing devices via printing facilities provided by the operating system. The computer includes a printing subsystem that can be customized to support various printers, usually through a software component such as a driver or plug-in.

The system 100 also includes a virtual printer driver or plug-in 104. In some embodiments, this contains a software implementation of methods described herein and also satisfies the requirements of the printing subsystem of the source device 102 so as to function as a virtual printing device.

The system 100 further includes a database 106. As used herein, the term “database” generally refers to a collection of cross-referenced records or files.

In some embodiments, the database 106 is a general purpose or custom software program for database management. In other embodiments the database 106 can be as simple as a structured storage methodology in a file system.

A database supporting general queries for content data look up is utilized for at least the content data and metadata extracted during the printing process. The database maintains an association between the visual representation, content data, and metadata. The database may physically exist on the source device 102, the display device 108, or any other single or network of computing systems acting as a database server and accessible by network connection or other electronic means. Non-limiting examples possible off the shelf database components include Oracle, MySQL, sqlite, or Microsoft Jet. The database could be relational, object oriented, or based on Resource Description Framework (RDF).

The system 100 can also include a display device 108. In some embodiments, this is a general purpose computing device having a display or monitor. In some embodiments, the display device 108 is a dedicated electronic display device such as an electronic book using, e.g., Liquid Crystal Display (LCD), Electronic Paper Display (EPD), or Organic Light Emitting Diode (OLED) display technology. Typically an application is run on this device that makes use of the database 106 created by the driver 104. The display device 108 includes the hardware component allowing the visual representation of the application may be displayed. This display device 108 may be the same device as the source device 102 in some embodiments. In some embodiments, the display device 108 and the source device 102 are separate systems. As previously discussed, the database 106 may be hosted on display device 108, but it should at least be available to the display device 108 through some means.

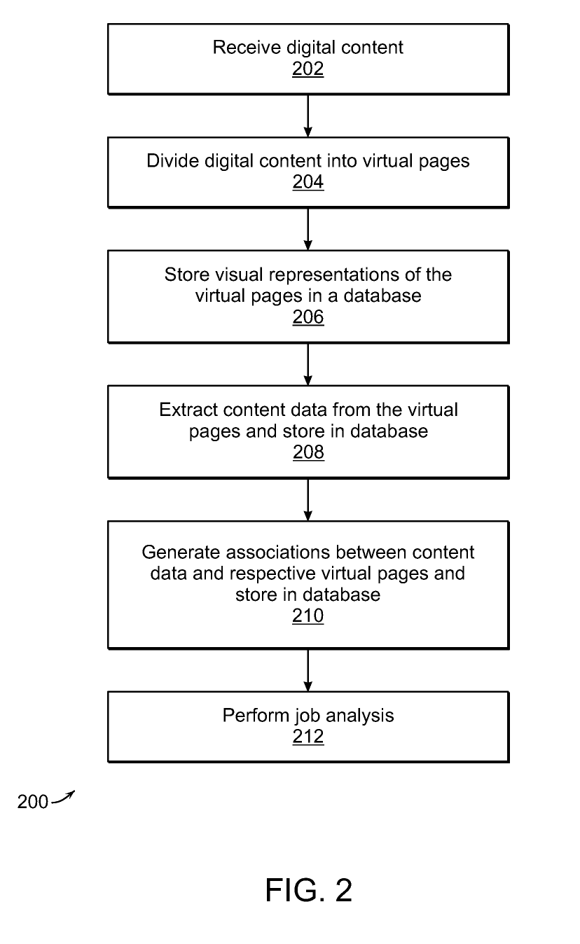

As described in further detail below, FIG. 2 illustrates a method of processing the output of the source device 102 using the virtual printer driver 104 to print digital content to a searchable electronic database format, and storing the results in the database 106.

As used herein the term “virtual page” refers to a logical unit of printable matter comprising text and/or graphics that is ordinarily intended to fit on a physical piece of paper.

The term “print job” generally refers to a series of one or more pages that are submitted to the print subsystem of the computer's operating system. Quite often pages in a print job are related in some way, and that is why they are being printed as a unit. This can contain useful metadata about the pages that can be used for searching across multi-page relationships.

The driver or virtual printer driver 104 is the software and supporting configuration installed on the computer's operating system to perform the functions described herein.

The following is an overview of print flow from an application running on a computer. When the application begins a print job, the driver is notified that a job is starting, and it may capture some metadata about the job at this point which can then be stored in the database.

The operating system may query the driver about its capabilities. The driver will indicate what print modes it supports, whether or not it can receive page description languages such as PostScript, how graphics should be represented (raster or vector), font options, and what text formatting is supported.

The application renders the print job by calling the operating system's print and/or graphics functions. The driver captures the visual representation as well as any text being printed.

The driver utilizes information about page orientation and dimensions to know when a page unit of printing has been completed.

When a page's visual representation and corresponding text has been captured, the driver then performs the page analysis as is described in further detail below.

An application then ends the print job. The driver is notified that the job has completed. The driver captures any final metadata about the print job and stores it in the database. The driver can then perform a job analysis as further described below.

FIG. 2 is a flowchart illustrating the process 200 of virtually printing digital content to a searchable database format in accordance with one or more embodiments of the invention.

At step 202, the virtual printer driver 104 receives the digital content to be processed.

At step 204, the driver 104 divides the digital content into one or more virtual pages, which may include accepting pre-defined page breaks.

At step 206, the driver 104 may store visual representations of the virtual pages in the database 106. The visual representations may differ in resolution, encoding, or in other ways. Alternately, the visual representations may be stored elsewhere, e.g., on the computer hosting the driver 104.

At step 208, the driver 104 extracts content data from the virtual pages and stores the content data in the database 106.

At step 210, the driver 104 generates associations between content data, metadata, and respective virtual pages, and stores the associations in the database 106.

At step 212, the driver performs an optional job analysis as will be described in further detail below.

In extracting content data from the virtual pages at step 208, the driver can optionally search the text for patterns that can be used to form associations with the virtual pages and stored in the database.

For the step of extracting content data, the driver 104 may or may not receive any text positioning information for text on the virtual pages. When text positioning information is provided, the driver collects the text elements and their positioning on the virtual pages.

Text element positioning information includes information on an area, typically a rectangle, on the virtual page defining the extents of where the text would be rendered in the page's coordinate system. The driver may additionally capture the text orientation and font information if it is available from the printer subsystem.

The driver applies an algorithm to analyze the spatial locations, orientations, and font information of each text segment and generates content data about the virtual page's text. The driver stores the content data in the database and associates it with the virtual page.

Steps in page-text analysis algorithm can include the following:

(1) The visual representation of the page is analyzed to find the locations of reference points/markers and/or edges using image processing techniques.

(2) The locations of target edges or reference points/markers are used to orient and scale the content layout information to the current virtual page.

(3) The adjusted content layout information is used to divide the page into zones.

(4) A zone is defined as a region on the page whose shape is specified in the same coordinate system as the text element positions are expressed.

(5) Each zone has at least one rule that can be applied to a text element's location to determine if the text is a member of the zone. An example rule is that the text element's left side must fall within the zone's rectangle but its right side may extend beyond the zone. Another rule specifies that a text element's extents must fall completely within a zone's rectangle to be considered part of the zone.

(6) A set of text elements is created for each zone where membership in the set is determined by the corresponding zone's rule as applied to each of the page's text elements.

(7) A zone's set of text elements, if it is not empty, may be stored in the database and associated with the virtual page. Alternately, it is recorded in the database that a zone was empty.

(9) The zone's set of text elements are further tested against the zone's other rules to find particular text patterns, and any text passing these tests is stored in the database and associated with the virtual page. These additional zone rules may be based on regular expressions that can require that the text match a given pattern or be of a certain length for example. Optical character recognition can be applied to the visual representation of the page in each zone to capture additional text that may not have been transmitted to the driver as a text element.

(10) The algorithm may use the results obtained so far to determine that a different document layout should be applied. In this case, the algorithm-determined document layout is loaded and algorithm steps are repeated.

Optionally, after each of the virtual pages has been analyzed, a job analysis process can be performed. The driver can apply an algorithm having the following steps to the overall results of each virtual page's analysis.

(1) The job analysis algorithm performs any text classification that requires knowledge of more than one virtual page's text.

(2) The job analysis algorithm corrects any misclassified text on the virtual pages where this can be determined.

(3) When particular content data is not found on a given virtual page, the job analysis algorithm can determine appropriate content data for the given page from one or more surrounding pages.

(4) The job analysis algorithm also generates additional metadata about the print job and stores this in the database.

(5) The job analysis algorithm may also add additional metadata to each virtual page's record in the database, associating them to multi-page metadata or job metadata.

### Example

### Analysis of a Common Aviation Approach Chart

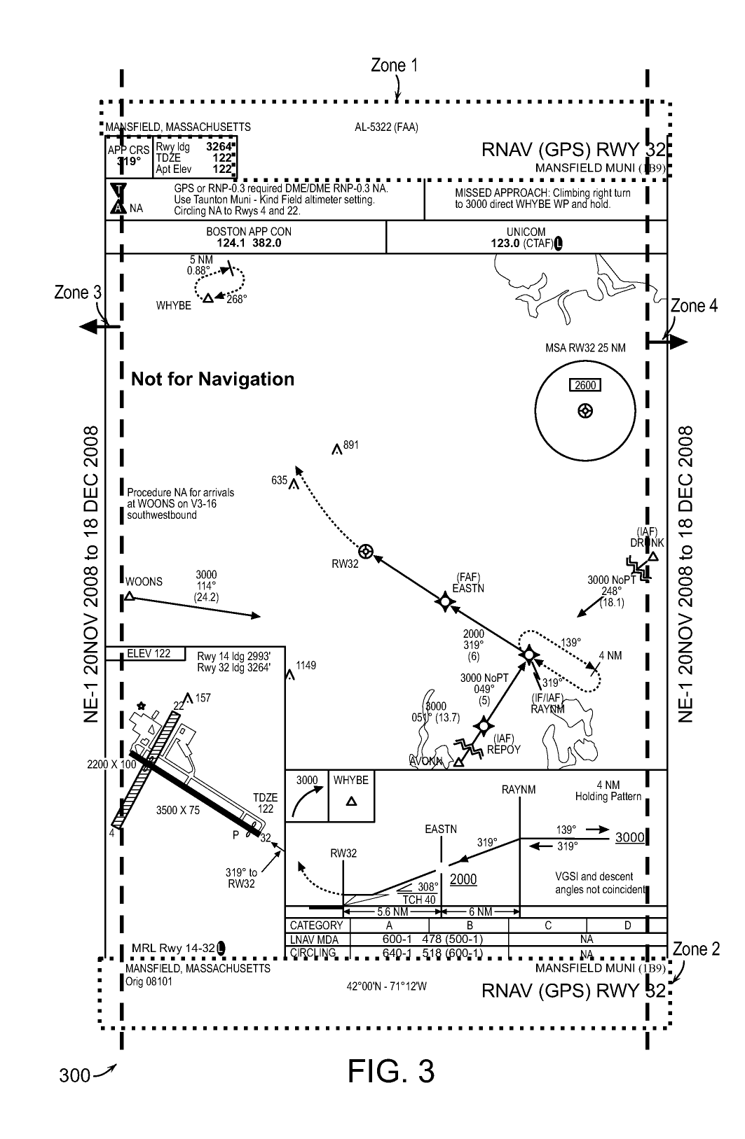

FIG. 3 illustrates an exemplary FAA approach chart having a given zone layout, which is used for locating content data from chart. An instrument rated pilot is qualified to land at many worldwide airports when weather conditions may not allow for visual acquisition of the runway until at a very low altitude. At such airports, special charts are required that encapsulate in detail the procedure for getting from a certain position in airspace at a higher altitude, to a much lower altitude very close to the landing runway. Such procedures are designed to take into consideration of terrain, obstacle, noise sensitivity, and issues specific to the airport location. A decision must be made by the pilot after completing the inbound portion of the procedure as to whether a safe landing can be made from this point or whether a missed approach must be declared and flown as detailed on the same chart.

An airport with such procedures may have just a single instrument approach or numerous different approaches that may utilize different runway surfaces, landing directions, and different navigational equipment and crew training requirements. There are other charts such as airport diagrams, noise abatement requirements, as well as detailed arrival and departure procedures that may be separately defined for busy airports. Various government agencies around the world are a source of such charts, but availability and chart format variation between different countries can become overwhelming. Most international flying and even much of the instrument flying done in the United States is done using materials provided by a company named Jeppesen (a Boeing Company). A legal equivalent to government charts worldwide, Jeppesen charts maintain a more consistent worldwide format.

Regardless of the source of the chart material, all this can lead to an extraordinary amount of paper information that must be carried by pilots operating under instrument flying regulations (IFR). For a commercial pilot covering a significant geography, it would not be unusual for all this paper and the related accessories to weigh on the order of 100 pounds. The pilot must locate the right pages from this volume of printed matter during preparation for the approach and may have to quickly switch charts if conditions change and air traffic control assigns a new approach, or even a new airport. In addition, the currency of the charts is a serious safety and legal issue for the pilot and major revisions are made as often as every 14 days. This may result in the manual, time consuming, and error prone process of frequently merging in updated pages.

Instrument approach charts have been made available for printing in an electronic form for some time. If printed to a database and used on a display device the weight, organization, and quick access issues are solved for the pilot and the automation of updates reduce errors in the collection of charts at hand. This demands an accurate extraction of certain content data during the printing process. In the example below, a standard United States FAA approach chart is used to demonstrate how a zone layout known a priori is used to extract the coded identifier for the airport, the airport name, airport location, and the approach name. With this information associated with the visual representation in the database, the pilot can quickly and easily find the required charts when provided with a software application to query the database and make selections.

The exemplary approach chart 300 of FIG. 3 is analyzed as follows:

All text to be identified falls in Zone 1 and can be verified by analysis of Zone 2. Zone 1 extends horizontally across the width of the chart and is constrained vertically by the top of the chart and the top-most lines drawn across the top of the chart as shown. Because of the upwardly protruding text box on the left hand side of the chart, Zone 1 is not a simple rectangle, rather a six sided polygon.

Zone 2 extends horizontally across the width of the chart and is constrained vertically by the bottom of the chart and the bottom-most lines drawn across the bottom of the chart as shown.

Zone 3's width is defined to be 6% of the total, cropped width of the chart. This zone extends vertically along the left side of the chart. This zone's rule is to accept text with a left extent falling in the zone, but no constraint on the right end of the text, i.e., it can flow out of the zone to the right.

Zone 4's width is defined to be 6% of the total, cropped width of the chart. This zone extends vertically along the right side of the chart. This zone's rule is to accept text with a right extent falling in the zone, but no constraint on the left end of the text.

Text falling within Zone 1, and having a left extent in Zone 3 can be searched for items such as the chart's location string (MANSFIELD, MASSACHUSETTS).

Text falling within Zone 1, and having a right extent in Zone 4 can be searched for items such as the approach name (RNAV (GPS) Rwy 32), airport name (MANSFIELD MUNI), and airport ICAO code (1B9).

Text falling within Zone 2, and having a left extent in Zone 3 can be searched to verify the chart's location string (MANSFIELD, MASSACHUSETTS).

Text falling within Zone 2, and having a right extent in Zone 4 can be searched to verify the approach name (RNAV (GPS) Rwy 32), airport name (MANSFIELD MUNI), and airport ICAO code (1B9).

Note that font, case, the brackets around the ICAO code (1B9) and the (GPS) designator, along with certain keyword markers such as RNAV, GPS, and RWY can further verify that the correct data element has been identified. Aviation charts are rich with consistent use of such identifiable markers. This example relies on a chart sourced from the FAA agency in the United State government, but a Jeppesen chart has been processed in an analogous manner.

Aviation approach charts represent only one very specific example of using techniques described herein in accordance with various embodiments. Some further applications of these techniques can, without limitation, include the following:

Every different word encountered, along with counts of the frequency of use could be easily collected in any text based process using the described methods. This could be used to form a comprehensive index for the visual representation of the digital content.

Electronic documents and other digital content often consistently utilize a collection of different fonts and character case to highlight certain types of information. For example, certain fonts may be used to call out different levels of heading and title within the digital content. With this knowledge, an accurate table of contents could be generated and stored in the database to quickly access the visual representation of the pages under different headings.

When printing from internet web browsers (such as Microsoft Internet Explorer and Mozilla Firefox), information is reliably available in the top and bottom margins, in addition to the text in the body of the page. Specifically the internet HTTP address, printing date, page number, and title are all easily extracted. With this information a database can be formed, in combination with methods highlighted in other examples, to facilitate queries against the content data. A history could even be formed for a webpage by storing a sequence of visual representations associated with that website, over time that could be used to track changes between samples in the sequence.

Many documents and other digital content utilize tags that label the information that follows. As an example, if an email is printed you are likely to see fields like From: <name and/or email address>, Sent: <date>, To: <email addresses>, Cc: <email addresses>, and Subject: <text>. These email document data fields are usually located near the top of the first printed page are thus very easily identified and extracted into a versatile database along with a visual representation of the document. This would facilitate a number of applications that would benefit archiving, moving, copying, etc of email data for flexible use outside of the email software program used.

As previously discussed, it is possible to apply the system to situations lacking printer subsystem support for the source digital content. A supporting example begins with source documents that are not in an electronic format (i.e., in hardcopy/paper form). Scanning the source documents can easily produce the electronic visual representation while OCR and image processing methods can be used to extract desired document data using the same methods presented for other examples. This would be useful to commit large volumes of printed matter to a database.

There are many electronic document subscriptions services including maintenance manuals for complex machinery to those following changes in the law that each exist to keep information up to date. Practicing professionals relying on these changing documents should have the latest information to appropriately perform their work. When used in a hardcopy form, changes are often provided in an update containing only changed material resulting in a similar, error prone merging process as the aviation chart example. If instead, the original source document and changes were digitized, they could be printed to a database at every update, with old pages being replaced by new based on date/time metadata associated with each page. Changed pages that are now obsolete could be retained so that changes over time could be reviewed.

It is to be understood that although the invention has been described above in terms of particular embodiments, the foregoing embodiments are provided as illustrative only, and do not limit or define the scope of the invention. Various other embodiments are also within the scope of the claims. For example, elements and components described herein may be further divided into additional components or joined together to form fewer components for performing the same functions.

The method steps described herein are preferably implemented in one or more computers. A representative computer is a personal computer or workstation platform that is, e.g., Intel Pentium, PowerPC or RISC based, and includes an operating system such as Windows, UNIX, MacOS or the like. As is well known, such machines include a display interface (a graphical user interface or “GUI”) and associated input devices (e.g., a keyboard or mouse).

The techniques described above are preferably implemented in software, and accordingly one of the preferred implementations of the invention is as a set of instructions (program code) in a code module resident in the random access memory of the computer. Until required by the computer, the set of instructions may be stored in another computer memory, e.g., in a hard disk drive, or in a removable memory such as an optical disk (for eventual use in a CD or DVD ROM), a removable storage device (e.g., external hard drive, memory card, or flash drive), or downloaded via the Internet or some other computer network. In addition, although the various methods described are conveniently implemented in one or more computers selectively activated or reconfigured by software, one of ordinary skill in the art would also recognize that such methods may be carried out in hardware, in firmware, or in more specialized apparatus constructed to perform the specified method steps.

Method claims set forth below having steps that are numbered or designated by letters should not be considered to be necessarily limited to the particular order in which the steps are recited.

What is claimed is:

1. A computer implemented method for virtually printing digital content to a searchable electronic database format to facilitate locating or analyzing desired content, the method comprising the steps of:
(a) providing digital content at a computer system;
(b) dividing the digital content into one or more virtual pages;
(c) extracting content data from the one or more virtual pages, and storing the content data in a database; and
(d) generating associations between the content data and respective virtual pages from which the content data was extracted, and storing the associations in a database.

2. The computer implemented method of claim 1 wherein the content data comprises text data or image data.

3. The computer implemented method of claim 1 further comprising storing visual representations of the one or more virtual pages in the database.

4. The computer implemented method of claim 1 further comprising extracting metadata from the one or more virtual pages, and storing the metadata in the database or using the metadata to generate the associations with virtual pages.

5. The computer implemented method of claim 4 wherein the metadata includes information on data element location and orientation in the one or more virtual pages, font information, document creation date information, author information, number of words on the page, or source information.

6. The computer implemented method of claim 5 wherein the information on data element location is determined based on locations of identifiable reference points, or edges of the page or patterns.

7. The computer implemented method of claim 1 wherein steps (b) through (d) are performed by a printer subsystem of the computer system.

8. The computer implemented method of claim 1 wherein step (c) comprises using optical character recognition or image analysis to extract content data from the one or more virtual pages.

9. The computer implemented method of claim 1 wherein step (c) comprises extracting the content data from known text positioning information on the one or more virtual pages.

10. The computer implemented method of claim 1 wherein one or more zones are defined for each virtual page based on expected, known, or derivable content layout information, and wherein step (c) further comprises applying at least one rule to each of the one or more zones to determine if a data element is present in the zone.

11. The computer implemented method of claim 10 wherein a data element determined to be in a given zone is associated with a virtual page stored in the database.

12. The computer implemented method of claim 1 wherein step (c) further comprises identifying content data comprising a text element in a virtual page based on a known text pattern or format.

13. The computer implemented method of claim 1 wherein step (c) further comprises identifying content data or metadata for a virtual page based on content data or metadata from other virtual pages.

14. The computer implemented method of claim 1 wherein the digital content comprises aviation charts, and wherein the content data for each virtual page of the document includes airport identification, airport location, or approach name.

15. A computer system for virtually printing digital content to a searchable electronic database format to facilitate locating or analyzing desired content, comprising:
at least one processor;
memory associated with the at least one processor; and
a program supported in the memory having a plurality of instructions which, when executed by the at least one processor, cause that processor to:
(a) divide the digital content into one or more virtual pages;
(b) extract content data from the one or more virtual pages, and store the content data in a database; and
(c) generate associations between the content data and respective virtual pages from which the content data was extracted, and store the associations in a database.

16. The computer system of claim 15 wherein the content data comprises text data or image data.

17. The computer system of claim 15 wherein the program further includes instructions that cause the processor to store visual representations of the one or more virtual pages in the database.

18. The computer system of claim 15 wherein the program further includes instructions that cause the processor to extract metadata from the one or more virtual pages, and store the metadata in the database or use the metadata to generate the associations with virtual pages.

19. The computer system of claim 18 wherein the metadata includes information on data element location and orientation in the one or more virtual pages, font information, document creation date information, author information, number of words on the page, or source information.

20. The computer system of claim 19 wherein the information on data element location is determined based on locations of identifiable reference points, or edges of the page or patterns.

21. The computer system of claim 15 wherein steps (a) through (c) are performed by a printer subsystem of the computer system.

22. The computer system of claim 15 wherein step (b) comprises using optical character recognition or image analysis to extract content data from the one or more virtual pages.

23. The computer system of claim 15 wherein step (b) comprises extracting the content data from known text positioning information on the one or more virtual pages.

24. The computer system of claim 15 wherein one or more zones are defined for each virtual page based on expected, known, or derivable content layout information, and wherein step (b) further comprises applying at least one rule to each of the one or more zones to determine if a data element is present in the zone.

25. The computer system of claim 24 wherein a data element determined to be in a given zone is associated with a virtual page stored in the database.

26. The computer system of claim 15 wherein step (c) further comprises identifying content data comprising a text element in a virtual page based on a known text pattern or format.

27. The computer system of claim 15 wherein step (c) further comprises identifying content data or metadata for a virtual page based on content data or metadata from other virtual pages.

28. The computer system of claim 15 wherein the digital content comprises aviation charts, and wherein the content data for each virtual page of the document includes airport identification, airport location, or approach name.

29. A computer program product for virtually printing digital content to a searchable electronic database format to facilitate locating or analyzing desired content, the computer program product residing on a computer readable medium having a plurality of instructions stored thereon which, when executed by the processor, cause that processor to:
(a) divide the digital content into one or more virtual pages;
(b) extract content data from the one or more virtual pages, and store the content data in a database; and
(c) generate associations between the content data and respective virtual pages from which the content data was extracted, and store the associations in a database.

30. The computer program product of claim 29 wherein the content data comprises text data or image data.

31. The computer program product of claim 29 further comprising instructions that cause the processor to store visual representations of the one or more virtual pages in the database.

32. The computer program product of claim 29 further comprising instructions that cause the processor to extract metadata from the one or more virtual pages, and store the metadata in the database or use the metadata to generate the associations with virtual pages.

33. The computer program product of claim 32 wherein the metadata includes information on data element location and orientation in the one or more virtual pages, font information, document creation date information, author information, number of words on the page, or source information.

34. The computer program product of claim 33 wherein the information on data element location is determined based on locations of identifiable reference points, or edges of the page or patterns.

35. The computer program product of claim 29 wherein steps (a) through (c) are performed by a printer subsystem of a computer system.

36. The computer program product of claim 29 wherein step (b) comprises using optical character recognition or image analysis to extract content data from the one or more virtual pages.

37. The computer program product of claim 29 wherein step (b) comprises extracting the content data from known text positioning information on the one or more virtual pages.

38. The computer program product of claim 29 wherein one or more zones are defined for each virtual page based on expected, known, or derivable content layout information, and wherein step (b) further comprises applying at least one rule to each of the one or more zones to determine if a data element is present in the zone.

39. The computer program product of claim 38 wherein a data element determined to be in a given zone is associated with a virtual page stored in the database.

40. The computer program product of claim 29 wherein step (c) further comprises identifying content data comprising a text element in a virtual page based on a known text pattern or format.

41. The computer program product of claim 29 wherein step (c) further comprises identifying content data or metadata for a virtual page based on content data or metadata from other virtual pages.

42. The computer program product of claim 29 wherein the digital content comprises aviation charts, and wherein the content data for each virtual page of the document includes airport identification, airport location, or approach name.
